(19) United States
(12) Patent Application Publication
(10) Pub. No.: US 2026/0125243 A1
(43) Pub. Date: May 7, 2026

(54) DRIVE TRAIN ASSEMBLY FOR A BELT DRIVE UNIT OF A LIFT SYSTEM AND CORRESPONDINGLY DESIGNED SHAFT AND USE THEREOF

(71) Applicant: TK ELEVATOR INNOVATION AND OPERATIONS GMBH, Düsseldorf (DE)

(72) Inventors: Alexander Wölfel, Stuttgart (DE); Andreas Wilhelm, Aichelberg (DE); Florian Otto, Filderstadt (DE); Aleksandr Gentner, Wendlingen (DE)

(21) Appl. No.: 19/118,114

(22) PCT Filed: Sep. 26, 2023
(86) PCT No.: PCT/EP2023/076546

§ 371 Date: Apr. 3, 2025

(30) Foreign Application Priority Data
Oct. 5, 2022 (DE) 10 2022 125 725.8

(51) Int. Cl. B66B 11/04; B66B 11/08; B66B 19/00

(52) U.S. Cl. CPC B66B 11/043; B66B 11/08; B66B 19/005

(57) ABSTRACT

Even when designing drivetrains for elevator installations, an advantageous compromise between required resources and achievable technical (performance) data is desirable. Especially in the case of drivetrains with a belt drive, the shaft interacting with at least one belt at a driving zone requires structural optimization in order to be able to make use of improvement potential including with regard to further components of the drivetrain. According to the disclosure, the shaft has an absolute shaft length which is predefined by length dimensioning with reference to the width of the driving zone. In this way, a particularly advantageous compromise on the basis of length dependency and optionally in addition also of diameter dependency can be found, in particular in terms of optimization concerning both the material-machining outlay and smallest possible dimensions, wherein the respective drivetrain, on the basis thereof, can also be designed for different applications.

### CROSS-REFERENCE TO RELATED APPLICATIONS

This application is a National Phase Entry under 35 U.S.C. § 371 of International Patent Application Serial No. PCT/EP2023/076546 filed Sep. 26, 2023, which claims the benefit of and priority to German Application Serial No. 10 2022 125 725.8 filed Oct. 5, 2022, the entire contents of both which are incorporated by reference in the present disclosure.

### TECHNICAL FIELD

The present disclosure relates to a drivetrain arrangement for a belt-drive unit of an elevator installation.

### BACKGROUND

In traction machines for elevator installations, inter alia material-efficient and space-saving construction is also of interest; this is also true of traction machines having a belt drive. A belt drive for an elevator installation has a shaft which is mounted in a housing and which has a driving zone via which the belt is guided and the torque is transmitted from the shaft. The shaft is mounted or supported in bearings on both sides of the driving zone. Here, it is the case that it is necessary to determine a respectively suitable construction of the drivetrain, on the one hand with regard to installation and mounting of the shaft, and on the other hand also with regard to material use and space requirement, whether in general or whether application-specific. The used/usable belt is predefined in particular by performance parameters, and therefore the task of the designer is inter alia to design the shaft or the whole drivetrain for different power levels or different applications in as scalable a manner as possible in such a way that, or to provide construction guidelines that are as generally applicable as possible such that, the aforementioned requirements can be met each as synergistically as possible.

According to the prior art, the shaft with driving zone is provided as standard in a configuration with a greater or lesser degree of standardization. On this basis, there is interest in an improved manner of designing the drivetrain, that is to say in technical teaching that makes it possible for the configuration in particular of the shaft to be optimized.

The publication US 2002/0100902 A1 describes variants of belt drives with in each case multiple belts which are guided around a shaft one next to the other in for example three or five driving-zone sections.

Proceeding from the prior art, there is felt to be a need for further structural optimization of the drivetrain of a belt drive for elevator installations, in particular regarding the dimensions of the shaft. Not least, in particular with regard to potential savings in connection with the resources used for the construction, there is also interest in technical teaching which can be used in as scalable a manner as possible for (structural) optimization of the shaft.

### SUMMARY

It is an object to provide a drivetrain arrangement in particular for elevator installations having a belt drive in the case of which the shaft is advantageously configured and dimensioned in terms of construction, with regard to a material-and cost-/resource-saving design. It is also an object to configure the shaft of a drivetrain arrangement for elevator installations with a belt drive in such a way that the shaft can advantageously interact in cooperation with further components of the drivetrain and can be advantageously installed.

Said object is achieved by a drivetrain arrangement as claimed in claim 1 and by a shaft designed therefor and the use thereof according to the respective alternative independent claim. Advantageous refinements of the disclosure are explained in the respective dependent claims. The features of the exemplary embodiments described below can be combined with one another, unless explicitly stated otherwise.

Provision is made of a drivetrain arrangement for a belt-drive unit of an elevator installation, having a shaft which has been mounted in a housing and on which a driving zone for at least one belt interacting with a/the belt-drive unit has been formed, wherein the driving zone has a driving-zone width, wherein the shaft has at least one section whose axial length has been dimensioned in a manner dependent on the driving-zone width;

According to the disclosure, it is proposed that the absolute length of the shaft is greater than the driving-zone width according to a predefined/predefinable length factor, wherein the predefined/predefinable length factor is smaller than an upper threshold value, specifically smaller than or equal to (<=) a length factor of 3.3. This also allows optimized dimensioning essentially based on requirements of the belt coupling. In this case, the disclosure is also based on the concept of keeping the construction as slender as possible and of providing an advantageous installation situation. In other words, the shaft can be dimensioned so as to be as slender as possible on the basis of the driving-zone width, in particular in that the shaft is dimensioned to be as short as possible.

The present disclosure relates to a drivetrain arrangement for a belt-drive unit of an elevator installation having a shaft which has been mounted in a housing and on which a driving zone for at least one belt interacting with a/the belt-drive unit has been formed, wherein the driving zone has a driving-zone width, wherein the length of the shaft has been dimensioned in a manner dependent on the driving-zone width. The present disclosure furthermore relates to a correspondingly designed shaft and to the use thereof, and to a correspondingly equipped elevator installation-In particular, the invention relates to a drivetrain arrangement according to the preamble of the independent claim.

The wording “according to at least one predefined/predefinable length factor” is in this case to be understood as meaning that the whole shaft can be dimensioned on the basis of a/the preferred width of the whole driving zone. Consequently, the disclosure is also based on the technical teaching of configuring the absolute dimensions of the shaft essentially by referring to the driving-zone width.

An “(absolute) driving-zone width” is to be understood here as being in particular the contact surface or running surface usable by the (respective) belt acting around the shaft. For the case in which the driving zone has been subdivided (in particular by webs) into at least two (for example three or four) driving-zone sections, the (absolute) driving-zone width is also to be understood here as being a longitudinal section of the shaft which is constructively considered for the configuration of (central) webs for guiding the respective belt; thus, the (absolute) driving-zone width is then made up of the widths of the individual driving-zone sections and the widths of the webs or shoulders provided for guiding the belts (or at least their structurally intended minimum width, for example 10% of the width of the respective driving-zone section, for example 5 mm for each shoulder or web). In the case of two driving-zone sections, an (absolute) driving-zone width is accordingly given by the sum of the width of the two driving-zone sections and the width of the central web and possibly also the width of two delimiting shoulders; in the case of three driving-zone sections, an (absolute) driving-zone width is accordingly given by the sum of the width of the three driving-zone sections and twice the width of the corresponding central web and possibly also the width of one or more laterally delimiting shoulders. Even for the case in which only one belt or only a single driving-zone section has been provided, this approximately 10% on both sides of the driving-zone section may need to be taken into account, in particular if, for this case, two shoulders are structurally provided too. Since, in terms of construction, shoulders do not necessarily have to have been/have to be included in planning as an integral constituent part of the shaft, but may be provided for example also by additional disks, the present disclosure relates to both variants: if no integral shoulders are provided, the corresponding indicated width relates to the length section provided for the driving zone in the context of the actually usable running surface for the belt(s) and a length section provided for disks or similar axial-delimitation means. In this respect, the expression “driving-zone width” is also to be understood as meaning a structural indicated length for the length section of the shaft, in particular between two bearing sections, to be correspondingly structurally included in planning for the correct functioning of the at least one belt.

A “shoulder” is to be understood here as meaning a lateral delimitation of the whole driving zone, which is preferably formed integrally in one piece on the shaft, “(shaft) shoulder”, or which can optionally also be connected to the shaft in the sense of an additional disk (attachment component) (cf. so-called flanged pulleys in standard belt drives). Unless explicitly described otherwise here, the shoulder is preferably formed integrally in one piece on the shaft, that is to say is formed by material machining on the shaft.

A “web” is to be understood here as meaning an elevation for subdividing the driving zone into individual driving-zone sections, in particular for a coupling with multiple belts, which are each intended to run on only one of the driving-zone sections in a manner separated from one another by the web. Also, unless expressly described otherwise here, the respective web is preferably formed integrally in one piece on the shaft, “(shaft) web”.

The shoulders and webs described herein may inter alia also perform the function of providing an abutment/stop/rolling surface for a belt hold-down unit.

An “(absolute) belt width” is to be understood here as meaning the cumulative width of the belts being used, that is to say, in the case for example of three belts, three times the width of the individual belt (assuming that all the belts have exactly the same width).

Here, the “driving-zone diameter” is to be understood as meaning the maximum diameter of a lateral surface of the driving zone, or of the corresponding driving-zone section (in the case of multiple belts), on which the belt interacts as intended with the shaft. Normally, the lateral surface of the driving zone is not strictly cylindrical, but of slightly cambered form (centering function for the belt); therefore, the driving-zone diameter is to be understood here as meaning that diameter which characterizes the greatest diameter normally in the central region of the driving zone or of the corresponding driving-zone section.

The length-dimensioning concept according to the disclosure may also be combined with diameter dimensioning, in the case of which reference may likewise be made to the driving zone. Advantageously, the driving-zone diameter is greater, according to at least one predefined (diameter) factor, than a/the shaft diameter at least in a section adjacent to the driving zone (excluding any shoulders delimiting the driving zone), in particular in a first and/or second bearing section for bearings delimiting the driving zone.

A “belt-drive unit” is to be understood here as meaning in particular a traction machine by means of which force can be transmitted from a/the motor to at least one traction means in the form of a belt, wherein the belt-drive unit is configured for accommodating, mounting and supporting a shaft interacting with the at least one traction means. Although the shaft may also be regarded as being a constituent part of the belt-drive unit, according to one of the exemplary embodiments, the belt-drive unit is configured to accommodate different shafts (for example according to power level or according to a predefined or desired number of belts), so that it is also possible for the belt-drive unit to be provided without a shaft. The belt-drive unit comprises at least the housing accommodating or at least holding the shaft and the motor or drive.

A “drivetrain arrangement” is to be understood here as meaning in particular the torque-transmitting components which interact with the at least one belt, in particular including a feather key and/or at least one toothing (shaft-hub connections in general); depending on the configuration of the shaft and of the bearings and depending on the desired installation sequence, the drivetrain arrangement may also comprise bearing components or the whole bearings. Depending on definition, the drivetrain arrangement may in this case also comprise the motor or drive of the belt-drive unit.

Personified expressions, unless worded with the neuter gender here, may apply to all genders in the context of the present disclosure. Any English-language expressions or abbreviations used here are in each case routine technical expressions in the art and are familiar in the English language to a person skilled in the art.

Here, the predefined/predefinable length factor is smaller than an upper threshold value, such as smaller than or equal to a length factor of 3.3. This results in a shaft that is as short as possible.

According to the disclosure, in embodiments, the predefined/predefinable length factor lies between 2.5 and 3.3. This allows an advantageous arrangement of further components interacting with the shaft with the shaft as short as possible, or with a driving zone which is comparatively wide in relation to the total extent of the shaft. In this respect, the present disclosure also makes a contribution in connection with belt drives that are as effective and high-powered as possible even with very high space requirements. Not least, it is in this way also possible for the dynamic (bending) loads exerted on the shaft and bearings to be minimized. It has been found here that the shaft should not be dimensioned to be noticeably shorter than the length factor of 2.5 of the driving-zone width, in particular so as to be able to avoid complications with regard to arrangement and support of the further components interacting with the shaft.

According to one exemplary embodiment, the predefined/predefinable length factor is smaller than (or smaller than or equal to) the upper threshold value 3.0. This results in an even more compact arrangement with further length optimization, for example also with regard to the relative width of webs/shoulders. The present disclosure, proceeding from force-transmission requirements for the driving zone, accordingly teaches arriving at an advantageously compact (length) dimensioning of the whole shaft in a relatively small length-variation window of only approximately 15% to approximately 20% length variation (from at least a factor of 2.5 to a maximum factor of 3.0 correspondingly only approximately 15%) during the design/dimensioning of the drivetrain such as also in conjunction with an advantageous diameter ratio.

According to one exemplary embodiment, provision is made of at least two driving-zone sections which together form the driving zone, such as at least two driving-zone sections with the same driving-zone diameter, such as at least two or at least three driving-zone sections which have been delimited from one another by a web in each case, said web being provided in an encircling manner on the shaft, in particular driving-zone sections with the same width. This not least also makes possible scaling with regard to the number of usable belts. The driving-zone sections may all have the same diameter (reference is made here to the greatest diameter in the case of the driving zone being of cambered form).

According to one exemplary embodiment, the shaft is configured to interact with at least two (for example three or four) belts which are guided on individual driving-zone sections of the driving zone, said driving-zone sections being delimited from one another such as by webs. This configuration, in combination with the further features described here, results in an advantageous (e.g., easily scalable) configuration and functioning of the drivetrain.

Advantageously, the shaft has two bearing sections, wherein the driving zone has been arranged between the bearing sections, such as directly adjacent to a/the first bearing section, which is provided for a first bearing (in particular fixed bearing), and/or directly adjacent to a/the second bearing section, which is provided for a second bearing (in particular floating bearing). In this case, it is possible to continue with or take on the diameter of the respective bearing section even without any noticeable further change in diameter up to the respective end of the shaft (possibly apart from very small steps or shaft shoulders or radii).

Advantageously, the driving zone has been/is delimited on both sides by bearing sections of the shaft. This at the same time also promotes an advantageous integration of the supporting function into a housing (forwarding of bearing force).

Advantageously, the shaft has the greatest diameter in the region of the driving zone (excluding any shoulders delimiting the driving zone and/or webs subdividing the driving zone into multiple sections) and has the second greatest diameter in the region of a first or second bearing section. This not least promotes an advantageous construction with regard to an at least approximately centered/central arrangement of the driving zone in relation to the total length of the shaft.

For example, provision is made of two or three driving-zone sections which together form the driving zone, wherein the driving-zone sections have been delimited from one another by a (central) web in each case, said web being provided in an encircling manner on the shaft, wherein the width of the (central) web is, in terms of magnitude, in the range of 3 to 15% of the width of the individual driving-zone section, such as at most at least approximately 10%. In this way, it is also possible for a usable running surface that is as large/wide as possible to be provided on a relatively short absolute width of the driving zone or length of the shaft section provided for this purpose.

According to one exemplary embodiment, the (absolute) width of the driving zone (or the axial length of the corresponding shaft section), including any shoulders and/or webs provided for delimiting driving-zone sections, lies in the range of 28 to 42% of the absolute length, such as in the range of 30 to 35% of the absolute length of the shaft. This also makes possible a relatively short structural length of the shaft and thus also a compact drive, wherein the available or active driving zone can be maximized. The shoulders may in this case be included, that is to say taken into account, in the (absolute) width of the driving zone, at least with a minimum width (included in planning in terms of construction) according to a web provided at multiple belts. An actual width of one of the shoulders may differ in individual cases, for example if the shoulder transitions into further shaft sections (e.g., without a distinctive step).

The aforementioned object is also achieved by a shaft for a drivetrain arrangement described herein, wherein the shaft diameter is greater both in a first and in a second bearing section for bearings that delimit the driving zone than the shaft diameter in a further section that is adjacent to the respective bearing section, wherein the width of the driving zone lies in the range of 28 to 42% of the absolute length of the shaft. In other words: The (absolute) length of the shaft section provided for the driving zone lies in the range of 28 to 42% of the absolute length of the shaft. This results in aforementioned advantages, such as with regard to measures at the shaft that are relatively simple to implement and nevertheless yield in numerous aspects advantages for the whole drivetrain.

Here, the shaft diameter may be greater both in a first and in a second bearing section for bearings that delimit the driving zone than the shaft diameter in a further section that is adjacent to the respective bearing section in the direction of the respective shaft end (excluding any shoulders delimiting the driving zone).

The shaft may have in front of the respective bearing section a shoulder which limits the (absolute) driving-zone width and is in this case dimensioned in such a way that the driving-zone width usable for at least one belt is shortened by at most 10%. The shoulders may in this case, for example, define an axial stop for the respective bearing and optionally also perform the function of a certain structural axial-length buffer, for example in order to allow an easier response to any desired variations in terms of power levels and/or desired absolute driving-zone width and/or belt width and/or bearing width. Not least, this axial-length buffer provided by at least one of the shoulders also allows potential variation/optimization possibilities with regard to an optimum ratio of belt width to width of correspondingly provided driving-zone section (which is in each case overdimensioned in terms of width by an advantageous factor in order to leave the belt freedom of movement in the axial longitudinal direction), such as without having to adapt the manner of the mounting of the shaft (and thus the housing) in the process. The optimization measures described here may accordingly have been implemented in such a way that structural clearances are still opened up.

The aforementioned object is also achieved by a belt-drive unit of an elevator installation, installed/installable in a drivetrain arrangement described herein, wherein the belt-drive unit is configured for coupling at least one drive of the belt-drive unit to at least one component to be driven of the elevator installation by at least one belt. This results in aforementioned advantages, with regard to an integration of the drivetrain components between drive and component to be driven of the elevator installation that is as slender as possible.

The aforementioned object is also achieved by an elevator installation having a drivetrain arrangement described herein and at least one belt-drive unit which is installed therein and couples at least one drive of the belt-drive unit to at least one component to be driven of the elevator installation by at least one belt. This makes it possible for aforementioned advantages to be realized.

The aforementioned object is also achieved by the use of a shaft, dimensioned in a manner optimized in terms of length, for a drivetrain arrangement of an elevator installation, in particular in a drivetrain arrangement described herein, for coupling at least one drive of a/the belt-drive unit of the elevator installation to at least one component to be driven of the elevator installation by at least one belt, wherein the shaft is mounted in bearings on both sides of a/the driving zone, wherein the shaft has at least one section whose axial length has been dimensioned in a manner dependent on the driving-zone width; wherein the absolute length of the shaft is greater than the driving-zone width according to a predefined length factor, wherein the predefined length factor is smaller than an upper threshold value, specifically smaller than a length factor of 3.3. This makes it possible for aforementioned advantages to be realized. In this case, the shaft, with regard to the (absolute) width of the driving zone, is dimensioned in terms of length in such a way that the absolute length of the shaft lies in the length-factor range of 2.5 to 3.3 of the (absolute) width of the driving zone.

Optionally, it is in this case additionally also possible for diameter-optimized dimensioning, likewise with reference to the dimension of the driving zone, to be realized, such as in that the diameter of the driving zone is greater according to at least one predefined (diameter) factor than the shaft diameter in both bearing sections adjacent to the driving zone (excluding any shoulders delimiting the driving zone).

Below, an explanation will be given of further features, which facilitate a still further-reaching structural optimization, in particular in the overall context, also with account taken of the requirements for the respective shaft diameter.

Advantageously, the driving-zone diameter is greater, according to at least one predefined (diameter) factor, than the shaft diameter at least in a section adjacent to the driving zone, in particular in a first and/or second bearing section for bearings delimiting the driving zone.

Advantageously, the size ratio of driving-zone diameter to shaft diameter is smaller than or equal to (<=) 2.0 in at least one bearing section, such as in both bearing sections of bearings delimiting the driving zone. This also promotes material machining that is, as far as possible, not too complicated; the corresponding bearing is designed to be relatively small, such as significantly smaller than a/the further bearing.

Advantageously, the size ratio of driving-zone diameter to shaft diameter is greater than or equal to (>=) 1.05, in particular in both bearing sections of bearings delimiting the driving zone. This not least also avoids overdimensioning.

Advantageously, the size ratio of driving-zone diameter to shaft diameter lies in the range of smaller than or equal to (<=) 2.0 to greater than or equal to (>=) 1.05 in at least one bearing section of bearings delimiting the driving zone, such as in both bearing sections of bearings delimiting the driving zone. This also results in an advantageous size gradation when realizing bearings of different sizes (if desired).

For example, the size ratio described here (driving-zone diameter to shaft diameter) is in the region of 1.8 in a first bearing section and in the region of 1.2 in a second bearing section (or vice versa), or is in each case more moderate with less variation in diameter of the bearing sections (for example 1.7 and 1.3).

It has been shown that, from a ratio of driving-zone diameter to shaft diameter of above 2.0 (that is to say a reciprocal of smaller than 0.5 for the ratio of shaft diameter to driving-zone diameter), the material machining of the shaft becomes relatively complicated. It has also been shown that, from a ratio of driving-zone diameter to shaft diameter of below 1.05 (that is to say a reciprocal of greater than 0.95 for the ratio of shaft diameter to driving-zone diameter), overdimensioning would occur (excessively thick shaft).

According to the present disclosure, in the case of indicated size ratios, the driving-zone diameter is preset because this serves as a reference variable. The indicated size ratio may however also be rendered in inverted form as a reciprocal or be used as a specification.

Advantageously, the size ratio of driving-zone diameter to shaft diameter lies in the range of 1.9 to 1.6, with a maximum deviation of 10%, in a first bearing section which receives a fixed bearing. This allows for example an advantageous bearing arrangement and fixing in connection to a brake unit, too.

Advantageously, the size ratio of driving-zone diameter to shaft diameter lies in the range of 1.1 to 1.4, with a maximum deviation of 10%, in a second bearing section which receives a floating bearing. This allows for example an advantageous bearing arrangement in combination with a rotor which is arranged rotationally conjointly on the shaft, too.

Here, it is the case that the diameter of the floating-bearing section at any rate is/remains greater than the diameter of the fixed-bearing section.

For example, for a diameter of the driving zone of approximately 75 mm or 80 mm, an absolute driving-zone width in the region of 105 mm can result in an absolute shaft length in the region of 335 mm (length ratio of approximately 31%), or an absolute driving-zone width in the region of 160 mm can result in an absolute shaft length in the region of 470 mm (length ratio of approximately 34%). For example, for a diameter of the driving zone of approximately 100 mm, an absolute driving-zone width in the region of 230 mm can result in an absolute shaft length in the region of 550 mm (length ratio of approximately 42%). It is of note that the indicated diameters indicated here are to be understood as being exemplary, that is to say the technical teaching of the present invention relating to the length dimensioning is based on the concept of dimensioning the absolute shaft length on the basis of the driving-zone width, that is to say largely independently of the driving-zone diameter; nevertheless, the exemplary indicated diameters indicated here can facilitate the understanding of the invention and can facilitate the realization of correspondingly advantageous configurations.

Summary: Even when designing drivetrains for elevator installations, an advantageous compromise between required resources and achievable technical (performance) data is desirable. Especially in the case of drivetrains with a belt drive, the shaft interacting with at least one belt at a driving zone requires structural optimization in order to be able to make use of improvement potential including with regard to further components of the drivetrain.

According to the invention, the shaft has an absolute length which is dimensioned in a manner dependent on the driving-zone width, wherein the driving-zone width is smaller than the absolute length by an advantageous length factor (or vice versa, wherein the absolute length is greater than the driving-zone width at most by an advantageous factor). Such length dimensioning with reference to the width of the driving zone allows a particularly advantageous compromise on the basis of length dependency to be found, in particular in terms of optimization concerning both the material-machining outlay and smallest possible dimensions (avoidance of overdimensioning), wherein the respective drivetrain, on the basis thereof, can also be designed in a simple manner for different applications in the context of a standardizable design guideline. Optionally, it is in this case also possible for dimensioning of at least one diameter of the shaft to be predefined in a manner dependent on the driving-zone diameter, that is to say for there to additionally also be diameter dependency.

### BRIEF DESCRIPTION OF THE FIGURES

In the figures of the drawing that follow, the invention will be described in more detail, wherein, for reference signs not explicitly described in a respective figure of the drawing, reference is made to the other figures of the drawing. In the figures:

FIG. 1 shows in a perspective side view a first type of shaft configured for a drivetrain arrangement according to exemplary embodiments;

FIG. 2 shows in a perspective side view a second type of shaft configured for the drivetrain arrangement according to exemplary embodiments;

FIG. 3 shows in a perspective side view a first type of shaft configured for a drivetrain arrangement according to exemplary embodiments;

FIG. 4 shows in a sectional side view a shaft configured for a drivetrain arrangement according to an exemplary embodiment;

FIG. 5 shows in a schematic illustration a drivetrain arrangement according to exemplary embodiments that is coupled to an elevator installation;

FIG. 6A shows in a perspective side view a belt-drive unit side of a motor with a shaft or drivetrain arrangement according to exemplary embodiments; and

FIG. 6B shows in a perspective side view pf the a belt drive unit of FIG. 6A from an opposite side view according to exemplary embodiments.

### DETAILED DESCRIPTION OF THE FIGURES

The disclosure will firstly be explained with general reference to all the reference signs and figures. Special features or individual aspects or aspects of the present disclosure that are clearly visible/presentable in the respective figure will be addressed individually in conjunction with the respective figure.

Provision is made of a drivetrain arrangement 10 for a belt-drive unit (traction machine) 20 such as for driving an elevator car 1 of an elevator installation 100, wherein a drive 23 has been coupled via a shaft 13 to at least one belt 21. The shaft 13 has been mounted in a housing 19 in a first bearing 11 (such as a fixed bearing) and a second bearing 12 (such as a floating bearing) in a first bearing section 13.1 and a second bearing section 13.2, wherein the at least one belt 21 is guided in a driving zone 13.4 which optionally includes multiple sections 13.5, wherein the sections 13.5 have been separated from one another by a web 13.3a in each case, and wherein the whole driving zone may optionally be delimited laterally by at least one shoulder 13.3. Provision may be made on one of the shaft ends of a toothing section 13.6 in particular for a rotationally conjoint arrangement of a component of a brake unit 17, and provision may be made on the other shaft end of a feather-key section 13.7 or a comparable rotationally conjoint coupling in relation to the rotor of the drive 23.

The following reference symbols denote in detail individual size-related or positional indications, wherein reference is made to the radial direction (r) and to the longitudinal direction x (axial direction):
B13 width or length section (absolute) between bearing seats/bearing surfaces which surround the driving zone; b13.3 width of an individual shoulder; b13.3a width of the individual (central) web; B13.4 absolute driving-zone width covering all the driving-zone sections and also the webs/shoulders provided for delimitation; b13.5 width of the individual driving-zone section (with averaged proportion of web/shoulder); b21 width of the individual belt, B21 absolute belt width of all the belts used; shaft diameter DO at the first end of the shaft (in particular in the toothing section); shaft diameter D1 in the first bearing section in particular directly adjacent to the driving zone, apart from a shoulder; (first) shoulder diameter D2 (or shaft diameter in the region of a first shoulder); driving-zone diameter D3 (or shaft diameter in the region of the driving zone); (central-)web diameter D4 (or shaft diameter in the region of a web); (second) shoulder diameter D5 (or shaft diameter in the region of a second shoulder); shaft diameter D6 in the second bearing section in particular directly adjacent to the driving zone, apart from a shoulder; shaft diameter D7 at the second shaft end (in particular in the feather-key section, rotor-coupling section); the absolute length of the shaft is denoted here by L13—according to the present disclosure, the absolute length L13 is limited structurally by a length factor with respect to the driving-zone width, for example a length factor of 3, a maximum length factor of 3.3. In this respect, the present invention also allows an advantageously large length of action relative to the absolute shaft length, with the advantageous effect that a highly compact belt-drive unit can be provided; it is as a consequence also possible for advantages in relation to the arrangement of the belt-drive unit in an (elevator) shaft relative to guide rails to be realized.

It is of note that the respective (shaft) shoulder 13.3, according to the present disclosure, is in the form of a one-sidedly separating step for limiting the belt movement (limitation of the desired axial degree of freedom of movement of the respective belt), and in that a/the (shaft) web 13.3a is provided as a central web in terms of configuration, that is to say acts in a separating manner on both sides and accordingly also provides an axial stop for two respective belts (the conceptual distinction between web and shoulder that is selected here is also to be understood in this respect). It is optionally also possible for provision to be made for axial delimitation of the feather-key section (or of an equivalent rotationally conjoint shaft-hub connection), such as by a shaft-shoulder step, which, however, may be of significantly flatter form than the shoulders for delimiting the driving zone that are described herein.

Provision may be made on the housing of guides, screens or such guide plates 19.9 for proper coupling-in/-out of the belt(s).

In the following text, special features of the invention will be explained with references to individual figures or exemplary embodiments.

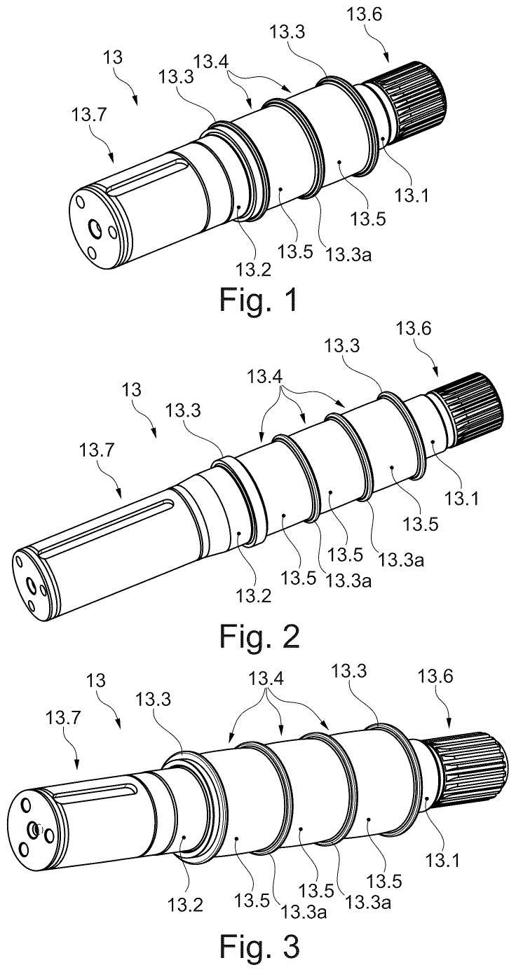

FIG. 1 shows a first type of shaft having the features according to the invention (belts not illustrated); the driving zone 13.4 has two driving-zone sections 13.5 which have been separated from one another by a web 13.3a. The driving-zone width B13.4 is smaller than the absolute shaft length according to an advantageous length factor (length-factor range), or vice versa (reciprocal). At the same time, it is also possible for the driving-zone diameter to be configured to be greater than the shaft diameter on both sides of the driving zone according to at least one advantageous factor. The factors in the longitudinal direction (length factors) and in the radial direction (diameter factor) may in this case be predefined largely independently of one another.

FIG. 2 shows a second type of shaft having the features according to the disclosure (belts not illustrated); the driving zone 13.4 has three driving-zone sections 13.5.

FIG. 3 shows a third type of shaft having the features according to the disclosure (belts not illustrated); the driving zone 13.4 has three driving-zone sections 13.5. This type differs slightly from the type shown in FIG. 2 with regard to the configuration of the shoulder 13.3 and the bearing section 13.2 between the feather-key section 13.7 and the driving zone 13.4.

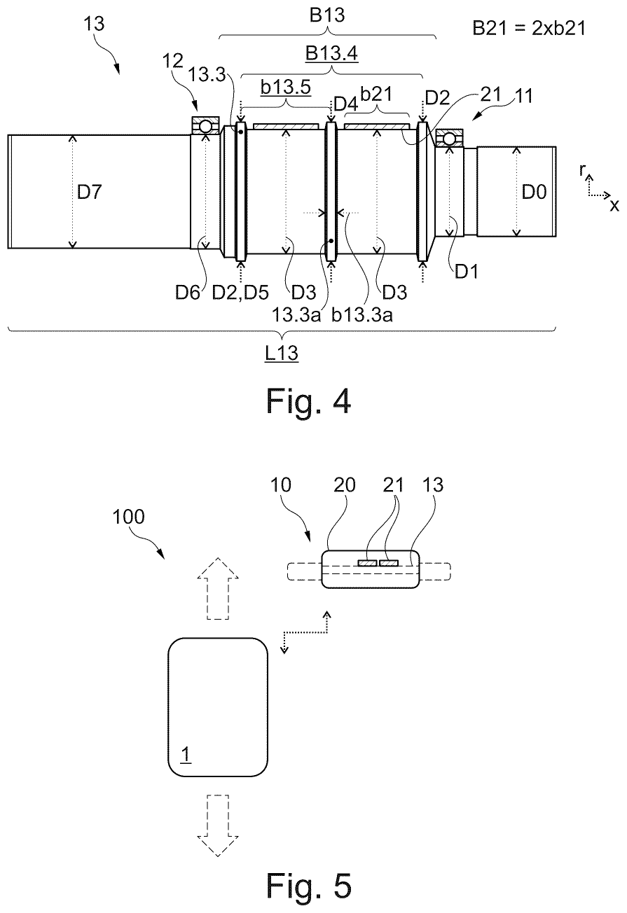

FIG. 4 shows a shaft having the features according to the disclosure with belts 21 present in the driving zone, with the individual size-related and positional indications being explained in detail. The design parameter according to the disclosure (reference variable of driving-zone width B13.4, b13.5, as specification for the absolute shaft length L13) is in each case emphasized by underlining here. It is also emphasized in FIG. 4 that the absolute belt width B21 in the case of (as provided here) two belts in use corresponds to twice the individual belt width b21, on the assumption that the belts in use have the same width (B21=2xb21).

FIG. 5 shows, roughly schematically, an interaction between the elevator car 1 and the drivetrain arrangement 10. The shaft described herein has been installed in the drivetrain arrangement 10. The positional relationship between the components shown is deliberately not specified here; in this respect, a person skilled in the art may provide a user-specific implementation.

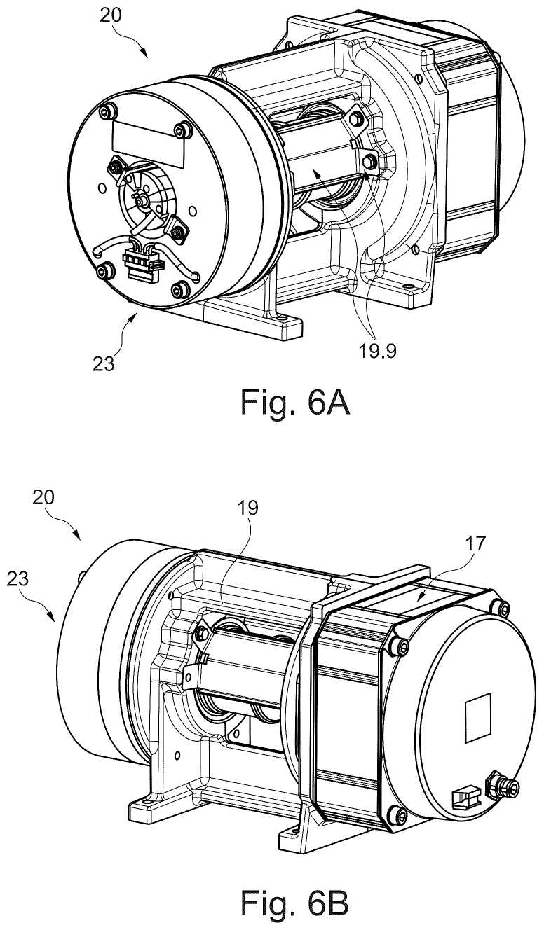

FIG. 6A shows the belt-drive unit 20 on the side of the drive or motor 23; in FIG. 6B, the opposite side, which is provided for the arrangement of the brake unit 17, is visible. It can be seen from FIGS. 6A-6B that the driving zone has been arranged largely centrally and the whole belt-drive unit 20 is of comparatively compact construction, such as due to the shaft, which has been dimensioned to be as short as possible according to the disclosure.

1. A drivetrain arrangement for a belt-drive unit of an elevator installation comprising:
a shaft which has been mounted in a housing and on which a driving zone for at least one belt interacting with a/the belt-drive unit has been formed, wherein the driving zone has a driving-zone width wherein the shaft has at least one section whose axial length has been dimensioned in a manner dependent on the driving-zone width; wherein the absolute length of the shaft is greater than the driving-zone width according to a predefined/predefinable length factor, wherein the predefined/predefinable length factor is smaller than an upper threshold value, wherein the predefined/predefinable length factor lies between 2.5 and 3.3.

2. The drivetrain arrangement according to claim 1, wherein the predefined/predefinable length factor is smaller than the upper threshold value 3.0.

3. The drivetrain arrangement according to claim 1, wherein provision is made of at least two driving-zone sections which together form the driving zone the at least two driving-zone sections with the same driving-zone diameter, the at least two have been separated from one another by a web in each case, said web being provided in an encircling manner on the shaft such that the driving-zone sections have the same width.

4. The drivetrain arrangement according to claim 1, wherein the shaft is configured to interact with at least two belts which are guided on individual driving-zone sections of the driving zone said driving-zone sections being separated from one another in particular by webs.

5. The drivetrain arrangement according to claim 1, wherein the shaft has two bearing sections wherein the driving zone has been arranged between the bearing sections, directly adjacent to a first bearing section, which is provided for a first bearing, or directly adjacent to a second bearing section, which is provided for a second bearing.

6. The drivetrain arrangement according to claim 1, wherein the driving zone is delimited on both sides by bearing sections of the shaft.

7. The drivetrain arrangement according to claim 1, wherein the shaft has the greatest diameter in the region of the driving zone and has the second greatest diameter in the region of a first or second bearing section.

8. The drivetrain arrangement according to claim 1, wherein provision is made of two or three driving-zone sections which together form the driving zone wherein the driving-zone sections have been separated from one another by a web in each case, said web being provided in an encircling manner on the shaft, wherein the width of the web is, in terms of magnitude, in the range of 3 to 15% of the width of the individual driving-zone section.

9. The drivetrain arrangement according to claim 1, wherein the width of the driving zone including any shoulders and webs provided for separating driving-zone sections lies in the range of 28 to 42% of the absolute length of the shaft.

10. The drivetrain arrangement according to claim 1, wherein the shaft diameter is greater both in a first and in a second bearing section for bearings that delimit the driving zone than the shaft diameter in a further section that is adjacent to the respective bearing section, wherein the width of the driving zone lies in the range of 28 to 42% of the absolute length of the shaft.

11. The drivetrain arrangement according to claim 1, wherein the belt-drive unit is configured for coupling at least one drive of the belt-drive unit to at least one component to be driven of the elevator installation by at least one belt.

12. (canceled)

13. A method for use of a shaft, dimensioned in a manner optimized in terms of length, for a drivetrain arrangement of an elevator installation, the method comprising:
coupling at least one drive of a belt-drive unit of the elevator installation to at least one component to be driven of the elevator installation by at least one belt, wherein the shaft is mounted in bearings on both sides of a/the driving zone wherein the shaft has at least one section whose axial length has been dimensioned in a manner dependent on the driving-zone width wherein the absolute length of the shaft is greater than the driving-zone width according to a predefined length factor, wherein the predefined length factor is smaller than an upper threshold value, specifically smaller than a length factor of 3.3, wherein the predefined/predefinable length factor lies between 2.5 and 3.3.
